(19) United States
(12) Patent Application Publication
(10) Pub. No.: US 2003/0093580 A1
(43) Pub. Date: May 15, 2003

(54) Method and system for information alerts

(75) Inventors: McGee Thomas, Garrison, NY (US); Agnihotri Lalitha, Fishkill, NY (US)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/053,451

(22) Filed: Nov. 9, 2001

(51) Int. Cl. G06F 9/46

(52) U.S. Cl. 709/318

(57) ABSTRACT

An information alert system and method are provided. Content from various sources, such as television, radio and/or Internet, are analyzed for the purpose of determining whether the content matches a predefined alert profile, which is manually or automatically created. An alert is then automatically created to permit access to the information in audio, video and/or textual form.

### BACKGROUND OF INVENTION

The invention relates to an information alert system and method and, more particularly, to a system and method for retrieving, processing and accessing, content from a variety of sources, such as radio, television or the Internet and alerting a user that content is available matching a predefined alert profile.

There are now a huge number of available television channels, radio signals and an almost endless stream of content accessible through the Internet. However, the huge amount of content can make it difficult to find the type of content a particular viewer might be seeking and, furthermore, to personalize the accessible information at various times of day. A viewer might be watching a movie on one channel and not be aware that his favorite star is being interviewed on a different channel or that an accident will close the bridge he needs to cross to get to work the next morning.

Radio stations are generally particularly difficult to search on a content basis. Television services provide viewing guides and, in certain cases, a viewer can flip to a guide channel and watch a cascading stream of program information that is airing or will be airing within various time intervals. The programs listed scroll by in order of channel and the viewer has no control over this scroll and often has to sit through the display of scores of channels before finding the desired program. In other systems, viewers access viewing guides on their television screens. These services generally do not allow the user to search for segments of particular content. For example, the viewer might only be interested in the sports segment of the local news broadcast if his favorite team is mentioned. However, a viewer must not know that his favorite star is in a movie he has not heard of and there is no way to know in advance whether a newscast contains emergency information he would need to know about.

On the Internet, the user looking for content can type a search request into a search engine. However, search engines can be inefficient to use and frequently direct users to undesirable or undesired websites. Moreover, these sites require users to log in and waste time before desired content is obtained.

U.S. Pat. No. 5,861,881, the contents of which are incorporated herein by reference, describes an interactive computer system which can operate on a computer network. Subscribers interact with an interactive program through the use of input devices and a personal computer or television. Multiple video/audio data streams may be received from a broadcast transmission source or may be resident in local or external storage. Thus, the '881 patent merely describes selecting one of alternate data streams from a set of predefined alternatives and provides no method for searching information relating to a viewer's interest to create an alert.

WO 00/16221, titled Interactive Play List Generation Using Annotations, the contents of which are incorporated herein by reference, describes how a plurality of user-selected annotations can be used to define a play list of media segments corresponding to those annotations. The user-selected annotations and their corresponding media segments can then be provided to the user in a seamless manner. A user interface allows the user to alter the play list and the order of annotations in the play list. Thus, the user interface identifies each annotation by a short subject line.

Thus, the '221 publication describes a completely manual way of generating play lists for video via a network computer system with a streaming video server. The user interface provides a window on the client computer that has a dual screen. One side of the screen contains an annotation list and the other is a media screen. The user selects video to be retrieved based on information in the annotation. However, the selections still need to be made by the user and are dependent on the accuracy and completeness of the interface. No automatic alerting mechanism is described.

EP 1 052 578 A2, titled Contents Extraction Method and System, the contents of which are incorporated herein by reference, describes a user characteristic data recording medium that is previously recorded with user characteristic data indicative of preferences for a user. It is loaded on the user terminal device so that the user characteristic data can be recorded on the user characteristic data recording medium and is input to the user terminal unit. In this manner, multimedia content can be automatically retrieved using the input user characteristics as retrieval keyboard identifying characteristics of the multimedia content which are of interest to the user. A desired content can be selected and extracted and be displayed based on the results of retrieval.

Thus, the system of the '578 publication searches content in a broadcast system or searches multimedia databases that match a viewer's interest. There is no description of segmenting video and retrieving sections, which can be achieved in accordance with the invention herein. This system also requires the use of key words to be attached to the multimedia content stored in database or sent in the broadcast system. Thus, it does not provide a system which is free of the use of key words sent or stored with the multimedia content. It does not provide a system that can use existing data, such as closed captions or voice recognition to automatically extract matches. The '578 reference also does not describe a system for extracting pertinent portions of a broadcast, such as only the local traffic segment of the morning news or any automatic alerting mechanism.

Accordingly, there does not exist fully convenient systems and methods for alerting a user that media content satisfying his personal interests is available.

### SUMMARY OF THE INVENTION

Generally speaking, in accordance with the invention, an information alert system and method are provided. Content from various sources, such as television, radio and/or Internet, are analyzed for the purpose of determining whether the content matches a predefined alert profile, which corresponds to a manually or automatically created user profile. The sources of content matching the profile are automatically made available to permit access to the information in audio, video and/or textual form. Some type of alerting device, such a flashing light, blinking icon, audible sound and the like can be used to let a user know that content matching the alert profile is available. In this manner, the universe of searchable media content can be narrowed to only those programs of interest to the user. Information retrieval, storage and/or display (visually or audibly) can be accomplished through a PDA, radio, computer, MP3 player, television and the like. Thus, the universe of media content sources is narrowed to a personalized set and the user can be alerted when matching content is available.

Accordingly, it is an object of the invention to provide an improved system and method for alerting users of the availability of profile matching media content on an automatic personalized basis.

The invention accordingly comprises the several steps and the relation of one or more of such steps with respect to each of the others, and the system embodying features of construction, combinations of elements and arrangements of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description, taken in connection with the accompanying drawings, in which:

FIG. 1 is a block diagram of an alert system in connection with a preferred embodiment of the invention; and

FIG. 2 is a flow chart depicting a method of identifying alerts in accordance with a preferred embodiment of the invention.

### DETAILED DESCRIPTION OF THE PREFERRED EMBODIMENTS

The invention is directed to an alert system and method which retrieves information from multiple media sources and compares it to a preselected or automatic profile of a user, to provide instantly accessible information in accordance with a personalized alert selection that can be automatically updated with the most current data so that the user has instant access to the most currently available data matching the alert profile. This data can be collected from a variety of sources, including radio, television and the Internet. After the data is collected, it can be made available for immediate viewing or listening or downloaded to a computer or other storage media and a user can further download information from that set of data.

Alerts can be displayed on several levels of emergency. For example dangerous emergencies might be displayed immediately with an audible signal, wherein interest match type alerts might be simply stored or a user might be notified via e-mail. The alert profile might also be edited for specific topics of temporal interest. For example, a user might be interested in celebrity alerts in the evening and traffic alerts in the morning.

A user can provide a profile which can be manually or automatically generated. For example, a user can provide each of the elements of the profile or select them from a list such as by clicking on a screen or pushing a button from a pre-established set of profiles such as weather, traffic, stars, war and so forth. A computer can then search television, radio and/or Internet signals to find items that match the profile. After this is accomplished, an alert indicator can be activated for accessing or storing the information in audio, video or textual form. Information retrieval, storage or display can then be accomplished by a PDA, radio, computer, television, VCR, TIVO, MP3 player and the like.

Thus, in one embodiment of the invention, a user types in or clicks on various alert profile selections with a computer or on screen with an interactive television system. The selected content is then downloaded for later viewing and/or made accessible to the user for immediate viewing. For example, if a user always wants to know if snow is coming, typing in SNOW could be used to find content matches and alert the user of snow reports. Alternatively, the user could be alerted to and have as accessible, all appearances of a star during that day, week or other predetermined period.

One specific non-limiting example would be for a user to define his profile as including storm, Mets, Aerosmith and Route 22. He could be alerted to and given access to weather reports regarding a storm, reports on the Mets and Aerosmith and whether he should know something about Route 22, his route to work each day. Stock market or investment information might be best accessed from various financial or news websites. In one embodiment of the invention, this information is only accessed as a result of a trigger, such as stock prices dropping and the user can be alerted via an indicator to the occurrence of the trigger. Thus, an investor in Cisco could be alerted to information regarding his investment; that the price has fallen below a pre-set level; or that a market index has fallen below some preset level.

This information could also be compiled and made accessible to the user, who would not have to flip through potentially hundreds of channels, radio stations and Internet sites, but would have information matching his preselected profile made directly available automatically. Moreover, if the user wanted to drive to work but has missed the broadcast of the local traffic report, he could access and play the traffic report back that mentioned his route, not traffic in other areas and would only do so if an alert was indicated. Also, he could obtain a text summary of the information or download the information to an audio system, such as an MP3 storage device. He could then listen to the traffic report that he had just missed after getting into his car.

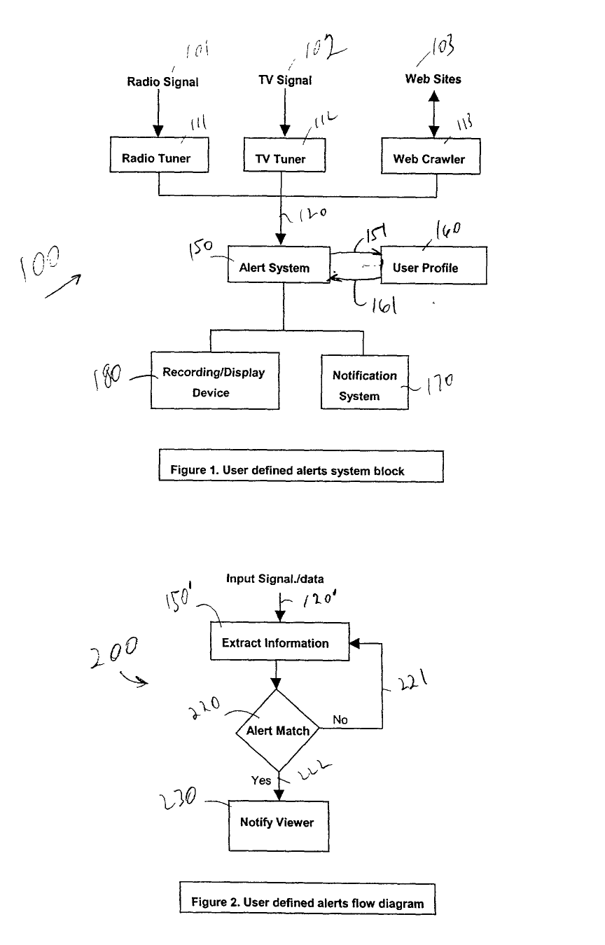

Turning now to FIG. 1, a block diagram of a system 100 is shown for receiving information, processing the information and making the information available to a user as an alert, in accordance with a non-limiting preferred embodiment of the invention. As shown in FIG. 1, system 100 is constantly receiving input from various broadcast sources. Thus, system 100 receives a radio signal 101, a television signal 102 and a website information signal via the Internet 103. Radio signal 101 is accessed via a radio tuner 111. Television signal 102 is accessed via a television tuner 112 and website signal 103 is accessed via a web crawler 113.

The type of information received would be received from all areas, and could include newscasts, sports information, weather reports, financial information, movies, comedies, traffic reports and so forth. A multi-source information signal 120 is then sent to alert system processor 150 which is constructed to analyze the signal to extract identifying information as discussed above and send a signal 151 to a user alert profile comparison processor 160. User alert profile processor 160 compares the identifying criteria to the alert profile and outputs a signal 161 indicating whether or not the particular content source meets the profile. Profile 160 can be created manually or selected from various preformatted profiles or automatically generated or modified. Thus, a preformatted profile can be edited to add or delete items that are not of interest to the user. In one embodiment of the invention, the system can be set to assess a user's viewing habits or interests and automatically edit or generate the profile based on this assessment. For example, if “Mets” is frequently present in information extracted from programs watched by a user, the system can edit the profile to search for “Mets” in the analyzed content.

If the information does not match profile, it is disregarded and system 100 continues the process of extracting additional information from the next source of content.

One preferred method of processing received information and comparing it to the profile is shown more clearly as a method 200 in the flowchart of FIG. 2. In method 200, an input signal 120′ is received from various content sources. In a step 150′, an alert processor 150 (FIG. 1), which could comprise a buffer and a computer, extracts information via closed-captioned information, audio to text recognition software, voice recognition software and so forth and performs key word searches automatically. For example, if instant information system 150 detected the word “Route 22” in the closed caption information associated with a television broadcast or the tag information of a website, it would alert the user and make that broadcast or website available. If it detected the voice pattern of a star through voice recognition processing, it could alert the user where to find content on the star.

In a step 220, the extracted information (signal 151 from step 220) is then compared to the user's profile. If the information does not match the user's interest 221, it is disregarded and the process of extracting information 150′ continues with the next source of content. When a match is found 222, the user is notified in step 230, such as via some type of audio, video or other notification system 170. The content matching the alert can be sent to a recording/display device 180, which can record the particular broadcast and/or display it to the user. The type of notification can depend on the level of the alert, as discussed above.

Thus, a user profile 160 is used to automatically select appropriate signals 120 from the various content sources 111, 112 and 113, to create alerts 180 containing all of the various sources which correspond to the desired information. Thus, system 100 can include downloading devices, so that information can be downloaded to, for example, a videocassette, an MP3 storage device, a PDA or any of various other storage/playback devices.

Furthermore, any or all of the components can be housed in a television set. Also, a dual or multiple tuner device can be provided, having one tuner for scanning and/or downloading and a second for current viewing.

In one embodiment of the invention, all of the information is downloaded to a computer and a user can simply flip through various sources until one is located which he desired to display.

In certain embodiments of the invention, storage/playback/download device can be a centralized server, controlled and accessed by a user's personalized profile. For example, a cable television provider could create a storage system for selectively storing information in accordance with user defined profiles and alert users to access the profile matching information. The matching could involve single words or strings of keywords. The keywords can be automatically expanded via a thesaurus or a program such as WordNet. The profile can also be time sensitive, searching different alert profiles during different time periods, such as for traffic alerts from, 6 a.m. until 8 a.m. An alert could also be tied to an area. For example, a user with relatives in Florida might be interested in alerts of floods and hurricanes in Florida. If traffic is identified via the alert system, it could link to a GPS system and plot an alternate route.

The signals containing content data can be analyzed so that relevant information can be extracted and compared to the profile in the following manner.

In one embodiment of the invention, each frame of the video signal can be analyzed to allow for segmentation of the video data. Such segmentation could include face detection, text detection and so forth. An audio component of the signal can be analyzed and speech to text conversion can be effected. Transcript data, such as closed-captioned data, can also be analyzed for key words and the like. Screen text can also be captured, pixel comparison or comparisons of DCT coefficient can be used to identify key frames and the key frames can be used to define content segments.

One method of extracting relevant information from video signals is described in U.S. Pat. No. 6,125,229 to Dimitrova et al. the entire disclosure of which is incorporated herein by reference, and briefly described below. Generally speaking the processor receives content and formats the video signals into frames representing pixel data (frame grabbing). It should be noted that the process of grabbing and analyzing frames is preferably performed at pre-defined intervals for each recording device. For example, when the processor begins analyzing the video signal, frames can be grabbed at a predefined interval, such as I frames in an MPEG stream or every 30 seconds and compared to each other to identify key frames.

Video segmentation is known in the art and is generally explained in the publications entitled, N. Dimitrova, T. McGee, L. Agnihotri, S. Dagtas, and R. Jasinschi, “On Selective Video Content Analysis and Filtering,” presented at SPIE Conference on Image and Video Databases, San Jose, 2000; and “Text, Speech, and Vision For Video Segmentation: The Infomedia Project” by A. Hauptmann and M. Smith, AAAI Fall 1995 Symposium on Computational Models for Integrating Language and Vision 1995, the entire disclosures of which are incorporated herein by reference. Any segment of the video portion of the recorded data including visual (e.g., a face) and/or text information relating to a person captured by the recording devices will indicate that the data relates to that particular individual and, thus, may be indexed according to such segments. As known in the art, video segmentation includes, but is not limited to:

Significant scene change detection: wherein consecutive video frames are compared to identify abrupt scene changes (hard cuts) or soft transitions (dissolve, fade-in and fade-out). An explanation of significant scene change detection is provided in the publication by N. Dimitrova, T. McGee, H. Elenbaas, entitled “Video Keyframe Extraction and Filtering: A Keyframe is Not a Keyframe to Everyone”, Proc. ACM Conf. on Knowledge and Information Management, pp. 113-120, 1997, the entire disclosure of which is incorporated herein by reference.

Face detection: wherein regions of each of the video frames are identified which contain skin-tone and which correspond to oval-like shapes. In the preferred embodiment, once a face image is identified, the image is compared to a database of known facial images stored in the memory to determine whether the facial image shown in the video frame corresponds to the user's viewing preference. An explanation of face detection is provided in the publication by Gang Wei and Ishwar K. Sethi, entitled “Face Detection for Image Annotation”, Pattern Recognition Letters, Vol. 20, No. 11, November 1999, the entire disclosure of which is incorporated herein by reference.

Frames can be analyzed so that screen text can be extracted as described in EP 1066577 titled System and Method for Analyzing Video Content in Detected Text in Video Frames, the contents of which are incorporated herein by reference.

Motion Estimation/Segmentation/Detection: wherein moving objects are determined in video sequences and the trajectory of the moving object is analyzed. In order to determine the movement of objects in video sequences, known operations such as optical flow estimation, motion compensation and motion segmentation are preferably employed. An explanation of motion estimation/segmentation/detection is provided in the publication by Patrick Bouthemy and Francois Edouard, entitled “Motion Segmentation and Qualitative Dynamic Scene Analysis from an Image Sequence”, International Journal of Computer Vision, Vol. 10, No. 2, pp. 157-182, April 1993, the entire disclosure of which is incorporated herein by reference.

The audio component of the video signal may also be analyzed and monitored for the occurrence of words/sounds that are relevant to the user's request. Audio segmentation includes the following types of analysis of video programs: speech-to-text conversion, audio effects and event detection, speaker identification, program identification, music classification, and dialog detection based on speaker identification.

Audio segmentation includes division of the audio signal into speech and non-speech portions. The first step in audio segmentation involves segment classification using low-level audio features such as bandwidth, energy and pitch. Channel separation is employed to separate simultaneously occurring audio components from each other (such as music and speech) such that each can be independently analyzed. Thereafter, the audio portion of the video (or audio) input is processed in different ways such as speech-to-text conversion, audio effects and events detection, and speaker identification. Audio segmentation is known in the art and is generally explained in the publication by E. Wold and T. Blum entitled “Content-Based Classification, Search, and Retrieval of Audio”, IEEE Multimedia, pp. 27-36, Fall 1996, the entire disclosure of which is incorporated herein by reference.

Speech-to-text conversion (known in the art, see for example, the publication by P. Beyerlein, X. Aubert, R. Haeb-Umbach, D. Klakow, M. Ulrich, A. Wendemuth and P. Wilcox, entitled “Automatic Transcription of English Broadcast News”, DARPA Broadcast News Transcription and Understanding Workshop, VA, Feb. 8-11, 1998, the entire disclosure of which is incorporated herein by reference) can be employed once the speech segments of the audio portion of the video signal are identified or isolated from background noise or music. The speech-to-text conversion can be used for applications such as keyword spotting with respect to event retrieval.

Audio effects can be used for detecting events (known in the art, see for example the publication by T. Blum, D. Keislar, J. Wheaton, and E. Wold, entitled “Audio Databases with Content-Based Retrieval”, Intelligent Multimedia Information Retrieval, AAAI Press, Menlo Park, Calif., pp. 113-135, 1997, the entire disclosure of which is incorporated herein by reference). Stories can be detected by identifying the sounds that may be associated with specific people or types of stories. For example, a lion roaring could be detected and the segment could then be characterized as a story about animals.

Speaker identification (known in the art, see for example, the publication by Nilesh V. Patel and Ishwar K. Sethi, entitled “Video Classification Using Speaker Identification”, IS&T SPIE Proceedings: Storage and Retrieval for Image and Video Databases V, pp. 218-225, San Jose, Calif., February 1997, the entire disclosure of which is incorporated herein by reference) involves analyzing the voice signature of speech present in the audio signal to determine the identity of the person speaking. Speaker identification can be used, for example, to search for a particular celebrity or politician.

Music classification involves analyzing the non-speech portion of the audio signal to determine the type of music (classical, rock, jazz, etc.) present. This is accomplished by analyzing, for example, the frequency, pitch, timbre, sound and melody of the non-speech portion of the audio signal and comparing the results of the analysis with known characteristics of specific types of music. Music classification is known in the art and explained generally in the publication entitled “Towards Music Understanding Without Separation: Segmenting Music With Correlogram Comodulation” by Eric D. Scheirer, 1999 IEEE Workshop on Applications of Signal Processing to Audio and Acoustics, New Paltz, NY October 17-20, 1999.

The various components of the video, audio, and transcript text are then analyzed according to a high level table of known cues for various story types. Each category of story preferably has knowledge tree that is an association table of keywords and categories. These cues may be set by the user in a user profile or pre-determined by a manufacturer. For instance, the “New York Jets” tree might include keywords such as sports, football, NFL, etc. In another example, a “presidential” story can be associated with visual segments, such as the presidential seal, pre-stored face data for George W. Bush, audio segments, such as cheering, and text segments, such as the word “president” and “Bush”. After a statistical processing, which is described below in further detail, a processor performs categorization using category vote histograms. By way of example, if a word in the text file matches a knowledge base keyword, then the corresponding category gets a vote. The probability, for each category, is given by the ratio between the total number of votes per keyword and the total number of votes for a text segment.

In a preferred embodiment, the various components of the segmented audio, video, and text segments are integrated to extract profile comparison information from the signal. Integration of the segmented audio, video, and text signals is preferred for complex extraction. For example, if the user desires alerts to programs about a former president, not only is face recognition useful (to identify the actor) but also speaker identification (to ensure the actor on the screen is speaking), speech to text conversion (to ensure the actor speaks the appropriate words) and motion estimation-segmentation-detection (to recognize the specified movements of the actor). Thus, an integrated approach to indexing is preferred and yields better results.

In one embodiment of the invention, system 100 of the present invention could be embodied in a product including a digital recorder. The digital recorder could include a content analyzer processing as well as a sufficient storage capacity to store the requisite content. Of course, one skilled in the art will recognize that a storage device could be located externally of the digital recorder and content analyzer. In addition, there is no need to house a digital recording system and content analyzer in a single package either and the content analyzer could also be packaged separately. In this example, a user would input request terms into the content analyzer using a separate input device. The content analyzer could be directly connected to one or more information sources. As the video signals, in the case of television, are buffered in memory of the content analyzer, content analysis can be performed on the video signal to extract relevant stories, as described above.

While the invention has been described in connection with preferred embodiments, it will be understood that modifications thereof within the principles outlined above will be evident to those skilled in the art and thus, the invention is not limited to the preferred embodiments but is intended to encompass such modifications.

What is claimed is:

1. A method of providing alerts to sources of media content, comprising:
establishing a profile corresponding to topics of interest;
automatically scanning available media sources, selecting a source and extracting from the selected media source, identifying information characterizing the content of the source;
comparing the identifying information to the profile and if a match is found, indicating the media source as available for access;
automatically scanning available media sources for a next source of media content and extracting identifying information from said next source and comparing the identifying information from said next source to the profile and if a match is found, indicating said next media source as available for access.

2. The method of claim 1, wherein the scanning and comparing steps are repeated until all available media sources are scanned.

3. The method of claim 1, wherein the available sources of media include television broadcasts.

4. The method of claim 1, wherein the available sources of media include television broadcasts and radio broadcasts.

5. The method of claim 1, wherein the available sources of media include television broadcasts and website information.

6. The method of claim 1 wherein identifying information of video sources is extracted by extracting closed caption information from the video signal source.

7. The method of claim 1, wherein identifying information is extracted using voice to text conversion processing.

8. The method of claim 1, wherein the identifying information is extracted using screen text extraction.

9. The method of claim 1, wherein identifying information is extracted using voice pattern or face pattern recognition.

10. The method of claim 1, wherein the sources of media content are made available at a first location and a user at a second location remote from the first location accesses the available sources of media content.

11. The method of claim 1, wherein one or more of the available media sources are recorded or downloaded and reviewed at a later time.

12. The method of claim 1, wherein the profile includes topics of interest.

13. The method of claim 1, wherein the profile includes topics of interest selected from the group consisting of sports, weather and traffic.

14. The method of claim 1, comprising the step of activating an alert available indicator when a profile match is made.

15. The method of claim 14, wherein the profile contains a plurality of topics of interest and different topics are associated with different alert levels and the different alert levels are associated with different types of alert available indicators.

16. The method of claim 14, wherein the indicator is an audible indicators.

17. The method of claim 14, wherein the indicator is a visible indicator.

18. A system for creating media alerts, comprising:
a receiver device constructed to receive and scan signals containing media content from multiple sources;
a storage device capable of receiving and storing user defined alert profile information;
a processor linked to the receiver and constructed to extract identifying information from a plurality of scanned signals containing media content;
a comparing device constructed to compare the extracted identifying information to the profile and when a match is detected, make the signal containing the media content available for review.

19. The system of claim 18, comprising an alert indicator which is activated when a match is detected.

20. The system of claim 18, wherein the receiver, processor and comparing device are constructed and arranged to scan through all media sources scannable by the receiver to compile a subset of available media sources for review, that match the profile.

21. The system of claim 18, including a computer constructed to receive user defined profile information and compare that information to the identifying information to identify matches.

22. The system of claim 18, wherein the receiver is constructed to receive television signals.

23. The system of claim 18, wherein the receiver comprises a first tuner constructed to process television signals and the system further comprises a second tuner constructed to assist in the display of either media available for review or other media.

24. The system of claim 18 comprising a tuner for processing radio signals.

25. The system of claim 18, comprising a web crawler.

26. The system of claim 18, wherein the receiver, storage device, processor and comparing device are housed within a television set.

27. The system of claim 18, wherein the receiver, storage device, processor and comparing device are operatively coupled to a television set.

28. The system of claim 18, wherein the storage device is constructed and arranged to receive the profile information from a keyboard.

29. The system of claim 18, wherein the storage device is constructed and arranged to receive the profile information from a signal generated when a user performs selected mouse clicks.

30. The system of claim 18, wherein the storage device contains a plurality of selectable predefined alert profiles.
